(19) United States
(12) Patent Application Publication
(10) Pub. No.: US 2016/0217806 A1
(43) Pub. Date: Jul. 28, 2016

(54) VOICE SIGNAL PROCESSING APPARATUS AND VOICE SIGNAL PROCESSING METHOD

(71) Applicant: Acer Incorporated, New Taipei City (TW)

(72) Inventors: Po-Jen Tu, New Taipei City (TW); Jia-Ren Chang, New Taipei City (TW); Kai-Meng Tzeng, New Taipei City (TW)

(21) Appl. No.: 14/737,500

(22) Filed: Jun. 12, 2015

(30) Foreign Application Priority Data
Jan. 22, 2015 (TW) 104102115

(51) Int. Cl. G10L 25/45

(52) U.S. Cl. CPC G10L 25/45

(57) ABSTRACT

A voice signal processing apparatus and a voice signal processing method are provided. Each frequency-lowered signal window included in a frequency-lowered sampling voice signal is divided into a first sub signal window that is faded-in and a second sub signal window that is faded-out. The first sub signal window and the second sub signal window that are adjacent to each other and belong to the different frequency-lowered signal windows are overlapped in order to generate an overlapping voice signal. The overlapping voice signal and the sampling voice signal are combined to generate an output signal.

### CROSS-REFERENCE TO RELATED APPLICATION

This application claims the priority benefit of Taiwan application serial no. 104102115, filed on Jan. 22, 2015. The entirety of the above-mentioned patent application is hereby incorporated by reference herein and made a part of this specification.

### BACKGROUND OF THE INVENTION

1. Field of the Invention

The invention relates to a signal processing apparatus, and more particularly, to a voice signal processing apparatus and a voice signal processing method.

2. Description of Related Art

In general, hearing-impaired people can clearly hear low frequency signals but have trouble receiving high frequency voice signals (e.g., a consonant signal). In the conventional technology, such issue is generally solved by lowering a frequency of the high frequency signal. However, an operation of lowering the frequency will extend a time length of the voice signal. Therefore, it is additionally required to determine and locate an interval not having the voice signal in between words, so as to perform a translation of time for the whole voice signal, and fill the frequency-lowered voice signal having the extended time length into the interval not having the voice signal. Only by doing so, the voice signals of other sections can be prevented from interference.

### SUMMARY OF THE INVENTION

The invention is directed to a voice signal processing apparatus and a voice signal processing method, and capable of effectively lowering a frequency of a voice signal without affecting voice signals of other sections.

A voice signal processing apparatus of the invention includes a processing unit, which lowers a frequency of a sampling voice signal to generate a frequency-lowered signal including a sequence of frequency-lowered signal windows. Each of the frequency-lowered signal windows does not include an overlapping data section. The processing unit further divides each of the frequency-lowered signal windows into a first sub signal window and a second sub signal window, performs a fade-in process and a fade-out process on the first sub signal window and the second sub signal window respectively, overlaps the first sub signal window and the second sub signal window adjacent to each other and belonging to the different frequency-lowered voice signal windows in order to generate an overlapping voice signal, and combines the sampling voice signal and the overlapping voice signal to generate an output signal.

In an embodiment of the invention, the processing unit further determines whether the sampling voice signal is a consonant signal, and lowers the frequency of the sampling voice signal if the sampling voice signal is the consonant signal.

In an embodiment of the invention, the processing unit determines whether the sampling voice signal is the consonant signal according to the frequency of the sampling voice signal.

In an embodiment of the invention, the voice signal processing apparatus further includes a filtering unit, which is coupled to the processing unit and capable of filtering an original voice signal to generate a filtered signal. The processing unit further samples the filtered signal to generate the sampling voice signal. The sampling voice signal includes a sequence of sampling signal windows, and each of the sampling signal windows does not include the overlapping data section.

In an embodiment of the invention, the filtering unit performs at least one of a low-pass filtering or a band-pass filtering on the original voice signal.

A voice signal processing method of the invention includes the following steps. A frequency of a sampling voice signal is lowered to generate a frequency-lowered signal including a sequence of frequency-lowered signal windows. Each of the frequency-lowered signal windows does not include an overlapping data section. Each of the frequency-lowered signal windows is divided into a first sub signal window and a second sub signal window. A fade-in process and a fade-out process are performed on the first sub signal window and the second sub signal window respectively. The first sub signal window and the second sub signal window adjacent to each other and belonging to the different frequency-lowered voice signal windows are overlapped in order to generate an overlapping voice signal. The sampling voice signal and the overlapping voice signal are combined to generate an output signal.

In an embodiment of the invention, the voice signal processing method further includes: determining whether the sampling voice signal is a consonant signal, and lowering the frequency of the sampling voice signal if the sampling voice signal is the consonant signal.

In an embodiment of the invention, the step of determining whether the sampling voice signal is the consonant signal includes: determining whether the sampling voice signal is the consonant signal according to the frequency of the sampling voice signal.

In an embodiment of the invention, the voice signal processing method further includes the following steps. An original voice signal is filtered to generate a filtered signal. The filtered signal is sampled to generate the sampling voice signal. The sampling voice signal includes a sequence of sampling signal windows, and each of the sampling signal windows does not include the overlapping data section.

In an embodiment of the invention, the step of filtering the original voice signal includes: performing at least one of a low-pass filtering or a band-pass filtering on the original voice signal.

Based on the above, according to the embodiments of the invention, each of the frequency-lowered signal windows included in the frequency-lowered sampling voice signal is divided into the first sub signal window that is faded-in and the second sub signal window that is faded-out, and then the first sub signal window and the second sub signal window adjacent to each other and belonging to the different frequency-lowered signal windows are overlapped to generate the overlapping voice signal to be combined with the sampling voice signal. As a result, the frequency of the voice signal may also be lowered without causing interference to the voice signals of the other sections.

To make the above features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a voice signal processing apparatus according to an embodiment of the invention.

FIG. 2 is a schematic diagram illustrating a frequency-lowered signal and an overlapping voice signal according to an embodiment of the invention.

FIG. 3 is a schematic flowchart illustrating a voice signal processing method according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

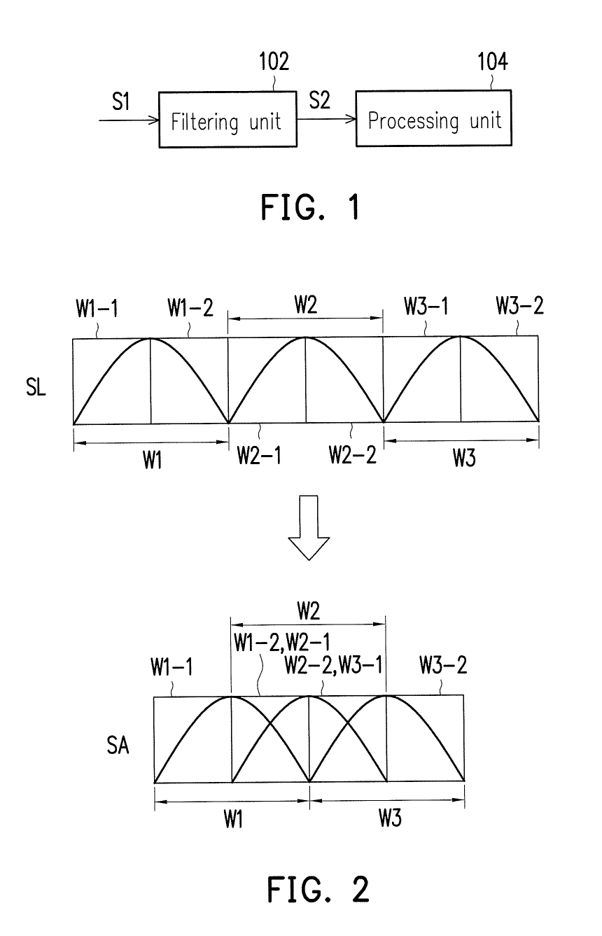

Referring to FIG. 1, FIG. 1 is a schematic diagram illustrating a voice signal processing apparatus according to an embodiment of the invention. The voice signal processing apparatus includes a filtering unit 102 and a processing unit 104. The filtering unit 102 is coupled to the processing unit 104. The filtering unit 102 may be, for example, implemented by at least one of a low-pass filter or a band-pass filter, and the processing unit 104 may be, for example, implemented by a central processing unit, but the invention is not limited to the above.

The filtering unit 102 is configured to filter an original signal S1 to generate a filtered signal S2 for the processing unit 104. The filtering method of the filtering unit 102 may include, for example, performing a low pass filtering and a band-pass filtering, or performing only one of the low pass filtering and the band-pass filtering on the original voice signal S1. The processing unit 104 may sample the filtered signal S2 to generate a sampling voice signal. The sampling voice signal includes a sequence of sampling signal windows, and each of the sampling signal windows does not include an overlapping data section. The processing unit 104 may determine whether the sampling voice signal is a consonant signal, and lower a frequency of the sampling voice signal if the sampling voice signal is the consonant signal. Whether the sampling voice signal is the consonant signal may be, for example, determined according to the frequency of the sampling voice signal. For instance, if the frequency of the sampling voice signal is higher than a predetermined frequency value, it is determined that the sampling voice signal is the consonant signal.

The processing unit 104 may generate a frequency-lowered signal including a sequence of frequency-lowered signal windows after lowering the frequency of the sampling voice signal. Because each of the sampling signal windows does not include the overlapping data section, each of the frequency-lowered signal windows in the frequency-lowered signal obtained after lowering the frequency of the sampling voice signal does not include the overlapping data section either. Subsequently, the processing unit 104 may divide each of the frequency-lowered signal window into a first sub signal window and a second sub signal window, perform a fade-in process and a fade-out process on the first sub signal window and the second sub signal window respectively, and then overlap the first sub signal window and the second sub signal window adjacent to each other and belonging to the different frequency-lowered voice signal windows in order to generate an overlapping voice signal. Thereafter, the processing unit 104 combines the sampling voice signal and the overlapping voice signal to generate an output signal.

For instance, referring to FIG. 2, FIG. 2 is a schematic diagram illustrating a frequency-lowered signal SL and an overlapping voice signal SA according to an embodiment of the invention. In the present embodiment, the frequency-lowered signal SL includes three frequency-lowered signal windows W1, W2 and W3, and each of the frequency-lowered signal windows is divided into the first sub signal window and the second sub signal window. As shown by FIG. 2, the frequency-lowered signal window W1 is divided into a first sub signal window W1-1 and a second sub signal window W1-2, the frequency-lowered signal window W2 is divided into a first sub signal window W2-1 and a second sub signal window W2-2, and the frequency-lowered signal window W3 is divided into a first sub signal window W3-1 and a second sub signal window W3-2. The fade-in process is performed on the first sub signal windows W1-1, W2-1 and W3-1, and the fade-out process is performed on the second sub signal windows W1-2, W2-2 and W3-2. In each of the frequency-lowered signal windows, the first sub signal window is a rising portion (i.e., a fade-in portion) and the second sub signal window is a sloping portion (i.e., a fade-out portion). In the present embodiment, window functions used for performing the fade-in process and the fade-out process on the frequency-lowered signal windows W1 to W3 are sinusoidal wave functions, but the invention is not limited thereto. In other embodiments, the window functions for the frequency-lowered signal windows W1 to W3 may also be other functions, such as triangular wave functions. After the fade-in process and the fade-out process are performed, the overlapping voice signal SA may be obtained by overlapping the first sub signal window and the second sub signal window adjacent to each other and belonging to the different frequency-lowered voice signal windows. As shown by FIG. 2, in the overlapping voice signal SA, the second sub signal window W1-2 of the frequency-lowered signal window W1 and the first sub signal window W2-1 of the frequency-lowered signal window W2 are overlapped. By analogy, the second sub signal window W2-2 of the frequency-lowered signal window W2 and the first sub signal window W3-1 of the frequency-lowered signal window W3 are also overlapped.

Because the sampling voice signal sampled and generated by the processing unit 104 of the foregoing embodiment includes the sequence of sampling signal windows and each of the sampling signal windows does not include the overlapping data section, an amount of operations may be substantially reduced when performing subsequent processes, such as lowering the frequency, dividing process and fade-in process, on the sampling signal windows. In addition, because the overlapping operation of the foregoing embodiment is performed only after lowering the frequency of the sampling voice signal, a number of the signal windows included in the overlapping voice signal SA is only one signal window more than that of the sampling voice signal. That is to say, eventually a time length of the overlapping voice signal SA to be combined with the sampling voice signal is almost identical to that of the sampling voice signal. Accordingly, the overlapping voice signal SA may be directly combined with the sampling voice signal without causing the interference to the voice signals of the other sections. In contrast, the overlapping operation is completed before lowering the frequency of the signal in the conventional technology. Therefore, the voice signal processing method of the conventional technology may prevent the voice signals of the other sections from the interference only if the interval not having the voice signal in between words is determined and located, the translation of time is performed for the whole voice signal, and the frequency-lowered voice signal having the extended time length is filled into the interval not having the voice signal.

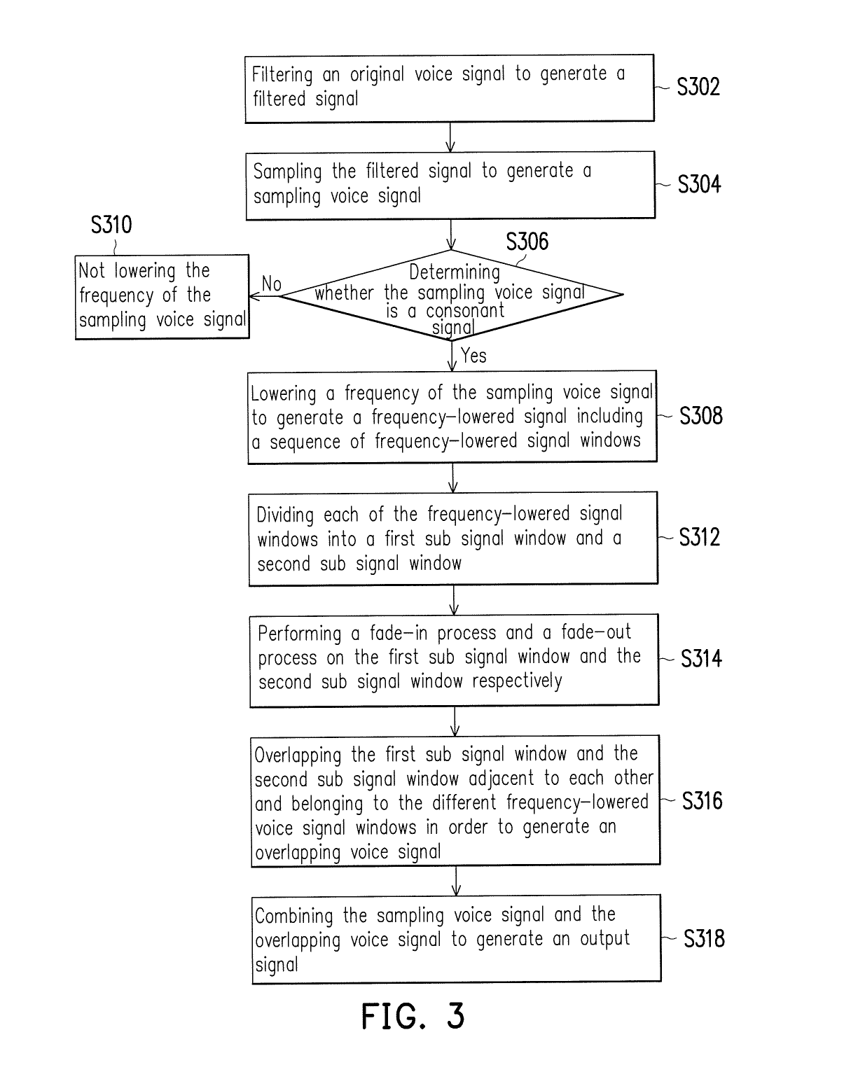

Referring to FIG. 3, FIG. 3 is a schematic diagram illustrating a voice signal processing method according to an embodiment of the invention. In view of the foregoing embodiments, a voice signal processing method of said voice signal processing apparatus may include the following steps. First, an original voice signal is filtered to generate a filtered signal (step S302). Herein, a method for filtering the original voice signal may include, for example, performing at least one of a low pass filtering and a band-pass filtering. Next, the filtered signal is sampled to generate a sampling voice signal (step S304). Herein, the sampling voice signal includes a sequence of sampling signal windows, and each of the sampling signal windows does not include an overlapping data section. Thereafter, whether the sampling voice signal is a consonant signal is determined (step S306), and a frequency of the sampling voice signal is lowered to generate a frequency-lowered signal including a sequence of frequency-lowered signal windows (step S308) if the sampling voice signal is the consonant signal. Herein, each of the frequency-lowered signal windows does not include the overlapping data section, and whether the sampling voice signal is the consonant signal may be determined according to the frequency of the sampling voice signal. Otherwise, if the sampling voice signal is not the consonant signal, the frequency of the sampling voice signal is not lowered (step S310). After the frequency of the sampling voice signal is lowered, each of the frequency-lowered signal windows is divided into a first sub signal window and a second sub signal window (step S312), a fade-in process and a fade-out process are performed on the first sub signal window and the second sub signal window respectively (step S314), and then the first sub signal window and the second sub signal window adjacent to each other and belonging to the different frequency-lowered voice signal windows are overlapped in order to generate an overlapping voice signal (step S316). Lastly, the sampling voice signal and the overlapping voice signal are combined to generate an output signal (step S318).

In summary, according to the embodiments of the invention, each of the frequency-lowered signal windows included in the frequency-lowered sampling voice signal is divided into the first sub signal window that is faded-in and the second sub signal window that is faded-out, and then the first sub signal window and the second sub signal window adjacent to each other and belonging to the different frequency-lowered signal windows are overlapped to generate the overlapping voice signal to be combined with the sampling voice signal. As a result, the amount of operations for the signals may be significantly reduced and the frequency of the voice signal may also be lowered without causing interference to the voice signals of the other sections.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A voice signal processing apparatus, comprising:
a processing unit, lowering a frequency of a sampling voice signal to generate a frequency-lowered signal including a sequence of frequency-lowered signal windows, wherein each of the frequency-lowered signal windows does not include an overlapping data section, and the processing unit further divides each of the frequency-lowered signal windows into a first sub signal window and a second sub signal window, performs a fade-in process and a fade-out process on the first sub signal window and the second sub signal window respectively, overlaps the first sub signal window and the second sub signal window adjacent to each other and belonging to the different frequency-lowered voice signal windows in order to generate an overlapping voice signal, and combines the sampling voice signal and the overlapping voice signal to generate an output signal.

2. The voice signal processing apparatus of claim 1, wherein the processing unit further determines whether the sampling voice signal is a consonant signal, and lowers the frequency of the sampling voice signal if the sampling voice signal is the consonant signal.

3. The voice signal processing apparatus of claim 2, wherein the processing unit determines whether the sampling voice signal is the consonant signal according to the frequency of the sampling voice signal.

4. The voice signal processing apparatus of claim 1, further comprising:
a filtering unit, coupled to the processing unit, and filtering an original voice signal to generate a filtered signal, wherein the processing unit further samples the filtered signal to generate the sampling voice signal, wherein the sampling voice signal comprises a sequence of sampling signal windows, and each of the sampling signal windows does not include the overlapping data section.

5. The voice signal processing apparatus of claim 4, wherein the filtering unit performs at least one of a low-pass filtering or a band-pass filtering on the original voice signal.

6. A voice signal processing method, further comprising:
lowering a frequency of a sampling voice signal to generate a frequency-lowered signal including a sequence of frequency-lowered signal windows, wherein each of the frequency-lowered signal windows does not include an overlapping data section;
dividing each of the frequency-lowered signal windows into a first sub signal window and a second sub signal window;
performing a fade-in process and a fade-out process on the first sub signal window and the second sub signal window respectively;
overlapping the first sub signal window and the second sub signal window adjacent to each other and belonging to the different frequency-lowered voice signal windows in order to generate an overlapping voice signal; and
combining the sampling voice signal and the overlapping voice signal to generate an output signal.

7. The voice signal processing method of claim 6, further comprising:
determining whether the sampling voice signal is a consonant signal, and lowering the frequency of the sampling voice signal if the sampling voice signal is the consonant signal.

8. The voice signal processing method of claim 7, wherein the step of determining whether the sampling voice signal is the consonant signal comprises:
determining whether the sampling voice signal is the consonant signal according to the frequency of the sampling voice signal.

9. The voice signal processing method of claim 6, further comprising:
filtering an original voice signal to generate a filtered signal; and
sampling the filtered signal to generate the sampling voice signal, wherein the sampling voice signal comprises a sequence of sampling signal windows, and each of the sampling signal windows does not include the overlapping data section;

10. The voice signal processing method of claim 9, wherein the step of filtering the original voice signal comprises:
performing at least one of a low-pass filtering or a band-pass filtering on the original voice signal.
